(19) United States
(12) Patent Application Publication
(10) Pub. No.: US 2015/0043254 A1
(43) Pub. Date: Feb. 12, 2015

(54) GRID FEED APPARATUS, ENERGY FEED SYSTEM AND METHOD FOR OPERATING A GRID FEED APPARATUS

(71) Applicant: LTi REEnergy GmbH, Unna (DE)

(72) Inventors: Heiko Preckwinkel, Dortmund (DE); Andreas Buente, Rheda-Wiedenbrueck (DE)

(21) Appl. No.: 14/378,406

(22) PCT Filed: Feb. 8, 2013
(86) PCT No.: PCT/EP2013/052568

§ 371 Date: Aug. 13, 2014

(30) Foreign Application Priority Data
Feb. 14, 2012 (DE) 10 2012 101 156.7

(51) Int. Cl. H02M 7/5395; H02M 7/5387

(52) U.S. Cl. CPC H02M 7/5395; H02M 7/53871
USPC 363/41

(57) ABSTRACT

The invention relates to a network feed device (10) for feeding electrical energy from a DC energy source (12) into a three-phase AC supply network (32), where the DC voltage of a DC intermediate circuit (24) is converted by means of at least one inverter unit (14) into a three-phase voltage and is fed by means of a transformer device (16) comprising three network transformer windings (38) into the AC supply network (24). The invention is characterized in that a first winding terminal of the network transformer windings (38) is connected to a half-bridge (30) of a first inverter device (14a), and a second winding terminal of the network transformer windings (38) of the transformer device (16) is connected to a half-bridge of a second inverter device (14b).

In subsidiary aspects, the invention relates to an energy feed system for the connection of a photovoltaic source, a fuel cell source, a battery source or a mechanically operated DC generator to an AC supply network or to an AC consumer, in particular a three-phase motor, and an operating method for energy-efficient voltage feeding.

### PRIOR ART

The present invention relates to a network feed device for feeding electrical energy from a direct-current energy source into an AC or three-phase supply network, where the DC voltage of a DC intermediate circuit is converted by means of at least one inverter unit into an AC or three-phase voltage and is fed by means of a transformer device into an AC supply network. Subsidiary aspects of the invention relate to an energy feed system for feeding DC voltage from a photovoltaic source, fuel cell, battery source or AC generator followed by a rectifier into an AC supply network, to an operating method for operating such a network feed device, and to the use of a network feed device for operating an AC consumer, in particular an AC motor. The device in accordance with the invention can in principle also be used for the reverse direction of energy flow, so that a DC consumer can be supplied with an adjustable intermediate circuit voltage.

Network feed devices with which the electrical energy from DC voltage sources such as batteries, photovoltaic cells, fuel cells or similar DC voltage sources can be converted into AC or three-phase energy and fed into a supply network are known from the prior art. Usually, a single inverter unit is used for this purpose, with the maximum three-phase output voltage being limited by the DC voltage made available by the DC voltage source. For example, the DC voltage is determined in photovoltaic feed systems by the voltage at the maximum power point (MPP) of the solar cell arrangement, i.e. that point on the current/voltage diagram of a solar cell at which the greatest power can be extracted, i.e. at which the product of current and voltage adopts a maximum value, and depends on the operating mode and type of a solar cell. An optimum efficiency can be achieved for the use of photovoltaic cells by exploiting the voltage at the MPP and the corresponding current, where on the other hand a high flexibility of the voltage configuration is wanted in the DC intermediate circuit of a network feed device. Since the highest possible AC voltage for feeding into the supply network results in a reduction in the magnitude of the current and is desirable for reasons of efficiency, the physical size and the costs of the components involved, so that the currents for the same power are correspondingly reduced by a high DC intermediate circuit voltage, thereby allowing the components to be longer-lasting, more economical and of smaller dimensions, it is desirable to try to maximize the deliverable AC voltage depending on the magnitude of the DC intermediate circuit voltage.

In the case of the three-phase inverter units known from the prior art, a transformer is supplied from a three-phase inverter, where as a rule the following relation applies to the maximum three-phase voltage in the photovoltaic field: U_{AC}<U_{MPPmin}/\sqrt{2}·0.9, where U_{MPPmin} is the minimum voltage at the MPP of the solar cell, where a 10% reserve is provided for regulation and for the compensation of tolerances, and a third harmonic zero sequence component is injected into the modulation. Typically, in an application in the photovoltaic field, a minimum DC intermediate circuit voltage of 450 V is provided, so that a maximum output voltage of about 290 V results for the line-to-line three-phase voltage. A three-phase voltage of this type is insufficient to feed a typical 400 V three-phase network, so that the network-side transformer, a boost converter or other measures for adjusting the voltage have to be used. As a result, in the case of a 100 kW system for example, there is a necessity for all the components on the AC voltage side, in other words the consumer network side, i.e. transformers, filters, chokes and output stages, to be dimensioned for a network current of up to 200 A, i.e. a comparably high current load, which makes the feed circuit correspondingly expensive, complex and less efficient. In addition, the high open-circuit voltage of photovoltaic cells usually means that semiconductors of the next higher voltage class have to be employed in the inverter, since it is not otherwise possible to modulate the inverter at the high intermediate circuit voltage that results.

The switching behaviour of inverter topologies known to date for network feeding via a network transformer causes harmonics in the output phases which act on the primary windings of a network transformer, resulting in high losses in the transformer and feeding a voltage into the network with a higher harmonic component. The losses lead to unwanted heating and reduce the efficiency of the network feed circuit. The service life of the circuit is reduced by a high power loss. For this reason, complex network or sine wave filters are frequently employed at the output of the inverter; these are relatively expensive, are of large physical size, and increase the susceptibility to failure and the costs of the network feed circuit.

Starting out from the prior art mentioned above, the object of the invention is to reduce the disadvantages of the known methods.

The above-named disadvantages are overcome by a device, a method and a use of a network feed device according to the independent claims. Advantageous developments of the invention are the subject matter of the dependent claims.

### DISCLOSURE OF THE INVENTION

In a first inventive aspect, a network feed device for feeding electrical energy from at least one DC energy source into an AC or three-phase supply network is proposed, where the DC voltage of a DC intermediate circuit is converted by means of at least one inverter unit into an AC or three-phase voltage and is fed into an AC supply network by means of a transformer device comprising three network transformer windings. For this purpose, it is proposed in accordance with the invention that a first winding terminal of the network transformer winding is connected to a half-bridge of a first inverter unit, and a second winding terminal of the network transformer winding of the transformer device is connected to a half-bridge of a second inverter unit. By operation of the network transformer windings between the half-bridges of two inverting units, the full range of the DC intermediate circuit voltage can be exploited in order to convert the DC voltage into a three-phase voltage. By operation of the primary-side transformer windings at the two inverter devices, the latter can be operated at an amplitude of the output voltage, averaged over a switching period, from DC+ to DC−. If this winding were to be alternatively operated with an inverter unit according to the prior art, then in the case of a star circuit (Y-circuit) only the amplitude averaged over a switching period (DC+−DC−)/\sqrt{3} is available to each winding, and in the case of a delta circuit the inverter unit must supply a current that is greater by the factor than what the winding of the transformer device accepts. These increased currents or reduced voltages can be avoided in the device in accordance with the invention, so that the AC output voltage can be increased by the factor \sqrt{3}.

It is thus proposed in accordance with the invention that a transformer with primary winding terminals that are brought out separately is used, so that in the transformer device in particular one independent potential, and preferably three, is externally accessible through the opened transformer windings with six terminals. Each of the first terminals of the primary windings of the transformer device is connected to a first inverter, and the second terminals of the respective primary windings are connected to a second frequency converter. By a coordinated operation of the two inverter units, it is for example possible to exploit the MPP voltage range of a solar cell arrangement flexibly, in order to utilize the maximum generator power. This optimizes the network feed power of the DC energy feed source. With the device in accordance with the invention, it is possible to provide a maximum AC output voltage, so that the corresponding power semiconductor components can be dimensioned for a lower current load, i.e. can have smaller dimensions and therefore be manufactured more economically. The lower currents in the inverter units result in reduced conduction and switching losses while improving the efficiency of the feed device. With the double inverter topology in accordance with the invention, the voltage potentials of the output phases L1U, L1V and L1W of the first inverter unit and the output phases L2U, L2V and L2W of the second inverter unit can be switched in finer stages independently of one another, whereby smaller voltage variations result and the harmonic component together with the associated losses can be lowered. The output voltage approaches a sinusoidal curve.

In an advantageous development of the invention, the first inverter unit can be operated synchronously with the network, in particular at 50 Hz or 60 Hz, to determine the polarity of the supply network voltage to be delivered, and the second inverter unit can be operated at a higher-frequency PWM (pulse width modulation) cycle, in particular greater than 500 Hz, and preferably at least 4 kHz, for modulation. Switching frequencies of 8 kHz, 16 kHz or above are also conceivable and advantageous. It is proposed in this development that the first inverter unit determines the polarity of the supply network voltage to be delivered, i.e. the positive or negative half-waves, and in this process is operated synchronously with the network at the required supply network frequency, usually at 50 Hz or 60 Hz, or, when driving a motor, at the required motor rotation speed. The second inverter unit is clocked at a frequency that is higher, for example by a factor of 10 to 100, and emits PWM signals for shaping a required signal form of the supply network voltage, in particular a sinusoidal signal form. These are used for modulation and matching the emitted voltage to the network voltage or to the required voltage form. Only low switching losses occur in the first inverter unit, so that the cooling system and the semiconductors can be designed using less expensive elements. Alternatively, both inverter units can be operated with a higher-frequency PWM clock, in particular greater than 500 Hz, preferably 4 kHz, for modulation of the supply network voltage to be delivered. In this case, the quality of the output voltage delivered can be further improved, in particular if the two inverter units are clocked with an offset of one half of a clock period. Thanks to the high-frequency switching operation of the second inverter unit, the output phase voltage between the associated phases L1U-L2U, L1V-L2V and L1W-L2W can be matched substantially more closely to a sinusoidal voltage curve, whereby harmonics can be further reduced, transformer and switching losses lowered and the service life extended. The network feed voltage provided closely approaches an ideal sinusoidal curve. This allows complex sinusoidal filters to be dispensed with, saving costs and space and reducing the susceptibility to faults. Instead, economical LC filters and smoothing units can be used in the output phases of the inverter units to the primary windings of the transformer device, or filtering measures can be dispensed with entirely. As a result of the higher voltages and reduced current of a double inverter rather than a single inverter topology, the filter and smoothing unit can be designed for lower current magnitudes.

According to an advantageous development of the invention, the transformer unit can be a three-phase transformer with separable primary winding terminals accessible from outside, where the two connecting terminals of each primary winding can be connected from outside, and each primary winding is preceded by a smoothing capacitor and a filter inductor. In this development, it is proposed that the usually present star node (neutral node) of the primary windings can be opened up, so that each primary winding can be connected in a manner accessible from outside. This enables each of the first connecting terminals to be connected to the first inverter unit and the second terminal of each primary winding to be connected to the second inverter unit. Each primary winding is preceded by a smoothing unit which usually comprises a filter capacitor and a filter inductor, in order to convert the generally binary switching signals emitted by the inverter units into a harmonically sinusoidal oscillation, in that the stored magnetic and electrical energies of the capacitor and the inductor are used to smooth the PWM signals. In this way, by opening up a star node of a transformer device known from the prior art, it can be made suitable for the connection of a network feed device in accordance with the invention. Depending on the design of the transformer it may be possible to dispense# with the filter device, or it may also be possible in some circumstances to connect a filter device on the secondary side.

It is recommended to connect an intermediate circuit capacitor, which is able to smooth and stabilize the intermediate circuit DC voltage in the DC intermediate circuit, between the at least one DC energy source and the two inverter units. This improves the stability of the DC intermediate circuit voltage, reduces harmonics and reduces interference losses.

In single inverter operation, and also in double inverter operation with two inverter units at a single DC energy source, harmonics and unwanted loop currents can occur in operation between the output phases of the inverter unit, increasing the current load and losses. A higher current load and the harmonic component reduce the service life of the circuit arrangement, while the losses on the one hand require an increase in the cooling for the power elements and transformer device, and on the other hand require cables and contacts with larger cross sections, lowering the overall efficiency of the circuit arrangement. In the final analysis, this creates a need for more powerful switching elements, entailing increased installation space and higher costs. Finally, the network feed voltage does not correspond to an ideal sinusoidal curve, hence leading to disturbances in the current network.

According to one advantageous embodiment, a filter and smoothing unit preferably comprising at least one filter capacitor and at least one filter inductor can be incorporated between the inverter units and the transformer device, in particular before each primary winding. The filter and smoothing unit is used to significantly reduce the harmonic component and to suppress loop currents, and so to increase the efficiency and the service life of the circuit arrangement and to approximate the output voltage to an ideal sinusoidal curve. The filter and smoothing unit can preferably be inserted into the supply lines to the transformer windings of the transformer device, and is designed in particular to suppress common-mode currents and to attenuate high-frequency oscillations. By the use of a simple LC network as a filter circuit, it is possible to dispense with complex network or sinusoidal filters having a large number of passive components such as X and Y capacitors.

According to one advantageous embodiment, a filter inductor of the filter and smoothing unit can be arranged in series with each primary winding. The filter inductor can be connected in an output phase of the first or second inverter unit and can be used to suppress harmonics, since the inductor provides an increased impedance for higher frequencies.

On this basis, the filter inductor can furthermore comprise two chokes that are inserted into the forward and reverse phases L1U-L2U, L1V-L2V, L1W-L2W of the primary winding. The above-mentioned filter inductor can hence be divided into two chokes and integrated into the two mutually corresponding drive phases of the two inverter units, whereby a simple parallel connection of inverter units can generally be implemented for increasing or scaling up the power.

Building in turn on this, the chokes of the filter inductor of the forward and return phases L1U-L2U, L1V-L2V, L1W-L2W can have a current-compensated design. This can be achieved in that, for example, the coils of the forward and return lines are wound in opposite phase on a common coil carrier, so that the magnetic fields of the forward and reverse lines cancel out, although common-mode components give rise to a high magnetic field and hence to a high impedance, as a result of which inefficient loop currents are heavily attenuated and a low-loss parallel connection of inverter units can be implemented.

In the proposed filter and smoothing unit, a filter inductor is generally assigned to each primary winding of the transformer device. The at least three filter inductors can advantageously be wound together on a multi-leg coil carrier, in particular a three-leg coil carrier, whereby on the one hand the magnetic circuits of the current flows can be linked together advantageously, and on the other hand a single, space-saving inductor component can be provided which, with small physical dimensions, can be integrated into an assembly of a double inverter device.

It is therefore possible in accordance with the preceding embodiments for the filter and smoothing unit to be advantageously a single-phase choke for each phase L2U, L2V, L2W or a divided and preferably current-compensated choke for the forward and return phases L1U-L2U, L1V-L2V, L1W-L2W. Preferably, the current-compensated choke can comprise a multi-leg filter choke for current-compensated attenuation of loop currents between the inverter units. A current-compensated choke has a plurality of identical windings through which current flows in opposite directions, so that the magnetic fields forming of the forward and return lines can compensate each other in order to eliminate interference currents. A common-mode current which can be caused by loop currents in the parallel operation of two inverter units at a single DC voltage source however generates a high inductance in the current-compensated choke, which has an attenuating effect, i.e. forms a high impedance with respect to the loop currents. It is desirable for this purpose that the current-compensated choke generates a high stray inductance; this can be achieved by the advantageously three-leg construction of the magnetic-field-carrying coil body, which in most cases consists of laminated metal sheet, where the forward and reverse lines of the three phases of the two inverter units L1U-L2U, L1V,-L2V, L1W-L2W are passed in pairs over one leg each. The stray inductance reduces the effect of harmonics due to the switching effects of the inverter units and attenuates disturbing loop currents.

According to one advantageous embodiment, two or more inverter units can be connected in parallel and operated synchronously to form an inverter unit, where the synchronized output phases L11U & L12U, L11V & L12V, L11W & L12W, L21U & L22U, L21V & L22V and L21W & L22W can be coupled to one another via chokes, preferably via a multi-leg choke for the suppression of harmonics and the reduction of loop currents. The single-phase chokes mentioned above can hence be divided between the forward and return lines, i.e. one choke is integrated into each of the L1U, L1V and L1W branches connecting the first inverter unit to the transformer device, and a corresponding choke into the L2U, L2V and L2W branch connecting the second inverter unit to the transformer device. This makes it possible to connect two or more inverter units in parallel to form one inverter unit, and to operate them in parallel, without the need for additional circuit measures to be taken to protect the inverter units. This allows for economical cascading for increasing the feed power, where a three-leg structure of the chokes with marked stray inductance as discussed above permits a compact construction. The required inductance of the LC network can be divided between two chokes which can each be advantageously arranged on one leg of a three-leg coil yoke. Ultimately it is advantageous and helpful in the case of parallel operation for the PWM clocking of the parallel-connected inverter units of each inverter unit to be synchronized, either by means of parallel wiring of the switching lines of the semiconductor switching units employed in the inverter unit, or by means of synchronized clocking of the PWM control units (pulse width modulation control units) associated with the two parallel-connected inverter units.

According to one advantageous embodiment of the parallel operation of inverter units, it is possible for at least the inverter units of a double inverter device and the associated output-side filter and smoothing units, i.e. the filter conductors and capacitors of the LC stage, to be brought together in a common assembly of a double inverter device. This makes it possible for two or more double inverter devices of this type to be connected in parallel, where the respective output phases L1U, L1V, L1W and L2U, L2V and L2W of the two inverter units included in the double inverter devices are connected to one another. The filter inductors here substantially permit the parallel operation and suppression of loop currents. The structural integration of the inverter units in one double inverter device allows a compact and economical scalability to be achieved. If necessary, appropriate circuit means can be used to connect a double inverter in parallel, where a high fault redundancy is also achieved and the delivered power can be scaled.

According to one advantageous development, at least the second inverter unit can be an inverter unit with 3 or more stages with a centre node. Such an inverter unit with 3 or more stages permits the output of at least three different voltage magnitudes in each polarity direction between the two inverter units, i.e. a zero voltage, an intermediate voltage and a maximum voltage close to the voltage magnitude of the DC intermediate circuit in the positive and negative direction, so that at least five different voltage magnitudes can be delivered, and hence a finer control of the PWM signals and an improved quality of the AC voltage to be delivered can be achieved. Such a 3-level inverter unit improves the efficiency. As a rule, both inverter units here share one intermediate circuit capacitor. To determine a zero voltage, the 3-stage inverter unit comprises a centre node if it is, for example, 3-stage inverter unit of the NPC type (neutral point clamped three level inverter), which can make a defined zero voltage available. Also conceivable and moreover advantageous is however the use of a multi-stage inverting unit which is however correspondingly expensive and can be operated with expensive technical control equipment.

As an alternative to a 3-or-more stage inverter unit with standard power conductors (IGBT switching transistors), the high PWM clock frequencies can be implemented by employing a two-point, three-point or higher-stage inverter unit with switching elements which have significantly lower conduction and/or switching losses, e.g. 2-point or 3-point inverter units based on silicon carbide (SiC) semiconductor elements or gallium arsenide (GaAs) semiconductor elements. These can also implement the required advantages of the invention when operated at a higher frequency than the inverter unit operated synchronously with the network; in particular, power semiconductor components of this type have very low switching losses and low conduction resistances.

On the basis of the above exemplary embodiment, it is possible according to an advantageous development to connect, in the DC intermediate circuit between the at least one DC energy source and the two inverter units, an intermediate circuit capacitor between the positive and negative intermediate circuit potentials and the centre node of the intermediate circuit respectively. It is hence proposed that two separate intermediate circuit capacitors are connected between the positive intermediate circuit potential and the centre node and between the negative intermediate circuit potential and the centre node, in order to provide an improved smoothing of the intermediate DC potential and a delivery of voltages from the 3-stage inverter unit with stable voltages. Both inverter units are connected to the same DC intermediate circuit. Dimensioning of the common intermediate circuit capacitance can be reduced as compared with the total of two separate DC intermediate circuits, so achieving a cost saving.

In one advantageous development, a switching device for decoupling from the inverter unit and/or for a star and/or delta connection of the winding terminals can be provided at the first and/or second winding terminals of the network transformer windings. A decoupling switching device separates the winding terminals from the corresponding inverter unit, for example in the event of a fault in the inverter unit or a collapse of the DC supply voltage of the inverter unit. In order to continue to operate the transformer device, the winding terminals are connected to one another in a star circuit by means of a star switching device, or in a delta by means of a delta switching device. Redundancy can be created in this way, increasing the security of the network feed device against failure. In a star circuit, the winding terminals that are connected to one of the inverter units are short-circuited. The associated inverter here is either electrically disconnected from the winding terminals, or it must be ensured that the associated inverter unit does not modulate shortly before and during the short-circuiting. The transformer device is hence changed over to a star circuit. This is advantageous at high intermediate circuit voltages, which sporadically occur in photovoltaic generators as a result of the MPP tracking. By switching over to a star circuit, the losses of the short-circuited inverter unit are avoided, and hence the overall efficiency of the network feed device can be further increased. This short-circuiting is also advantageous in the event that the associated inverter fails as a result of a fault, since this measure allows the system to continue in operation. The short-circuiting of the ends of the primary windings to the inverter unit can in particular be achieved by means of contactors, relays or electronic switches. In a delta circuit, the windings are connected in series, in particular by means of contactors, relays or electronic switches. In this case, some of the time only one of the two inverter units, which is fitted with semiconductors able to withstand higher voltages, is in operation. In this operating mode, the network feed device can be operated with intermediate circuit voltages which may not be appropriate for the second inverter unit. This solves, for example, the problem of the high open-circuit voltages of the photovoltaic generators.

In an advantageous development, the first inverter unit can be connected to a first DC energy source, and the second inverter unit to a second DC energy source. This makes it possible to use inverter units dimensioned for lower power in order to feed in a higher power. If one of the two DC energy sources fails, the second continues to be available to supply the network with a reduced power. Increased redundancy and security against failure are achieved. The two inverter units are therefore connected in a configuration in which each inverter unit is assigned a separate DC source or DC consumer and a separate intermediate circuit unit. The two inverter units are connected to one another on the DC side by a maximum of one connection. In this configuration, two DC sources such as photovoltaic generators, batteries or fuel cells can be operated separately from one another, and their operating point adjusted. In particular, two photovoltaic generators can thus be independently optimized in respect of their MPP points.

In a subsidiary aspect, an energy feed system is proposed comprising a DC energy source, for example a photovoltaic energy source, a fuel cell energy source, a battery energy source, a mechanically operable generator with rectifier equipped with a network feed device according to one of the previously mentioned exemplary embodiments. The DC energy source can be a photovoltaic source, a fuel cell source, a battery source or a generator, preferably a synchronous generator with attached rectifier. In particular, during operation as a photovoltaic energy source it is possible to enable an increased efficiency by operation at the MPP voltage at which the highest power of the photovoltaic cell can be achieved.

In a further subsidiary aspect of the invention, a method for operating a network feed device is proposed in which the first and second inverter units operate in a coordinated manner such that the voltage acting on each primary coil of the transformer device can be adjusted to an amplitude between 0 V up to the intermediate circuit potential DC+/DC−. A voltage can hence be provided between the first and second inverter units with an amplitude averaged over one switching period that varies adjustably between zero and the DC intermediate circuit voltage. The total voltage variation of the intermediate circuit is available for modulation of the respective half-wave. A high-frequency operation of the second inverter unit for modulation of the AC voltage to be delivered is particularly advantageous here.

On the basis of the above-mentioned method, it can be advantageous if the first inverter unit is operated for determining the polarity of the supply network voltage to be delivered synchronously with the network frequency, in particular in a 50 Hz or 60 Hz cycle, or in a cycle corresponding to the rotation speed of the motor, and for the second inverter units to be operated at a higher frequency, in particular for PWM clocking in a range that as a rule is at least 10 times higher in frequency, in particular greater than 500 Hz, preferably 4 kHz, for modulation of the supply network voltage to be delivered. The first inverter unit therefore determines the polarity of the AC voltage to be delivered as a positive or negative half-wave, while the second inverter unit can, by PWM modulation, perform a modulation of a sinusoidal AC voltage curve to be delivered. It is favourable for this purpose for the second inverter unit to be switched at high frequency, in particular at a clock frequency of 4 kHz, 8 kHz or 16 kHz, in order to generate as few harmonic components as possible and to provide a harmonic curve of the AC voltage.

In a further advantageous implementation of the above-mentioned method, it is possible for at least the second inverter unit to be switched in at least three voltage stages for PWM modulation of the supply network voltage. For this purpose, the second inverter unit is implemented as an inverter unit with 3 or more stages, in order to achieve the most accurate and exact influence possible on the AC voltage to be delivered. As a result, the form factor of the alternating voltage to be delivered is improved in respect of an ideal sinusoidal oscillation, harmonics are reduced and thus, in combination with a lower current load and lower switching losses, the overall efficiency is increased, so that smaller, more economical and longer-lasting semiconductor components, transformer components, cables, filters and heatsinks can be employed.

In a further aspect, the invention relates to the use of a network feed device for coupling a photovoltaic source, a fuel cell source, a battery source or a mechanically operable generator with rectifier, preferably a synchronous generator, to an AC supply network, or for operating an AC consumer, in particular an AC motor, where preferably the operation of the inverter unit is performed with a variable frequency corresponding to the speed of rotation of the AC motor. It is possible here to use the above-mentioned network feed device for operating a synchronous or asynchronous three-phase motor, where the first and second inverter units are to be operated in a correspondingly frequency-variable manner depending on the power and rotation speed that the AC motor is to provide. In the most favourable case, the first inverter unit here is operated corresponding to the speed of rotation that the motor is to provide, and the second inverter unit clocked at a higher frequency, for example a frequency higher by a factor of 10 to 100 than the first inverter unit, for modulation of the AC voltage to be delivered. In this way, an improved efficiency, lower switching losses and an efficient utilization of the voltage potential of the DC intermediate circuit is achieved.

When using an above-mentioned network feed device, a direct energy feed on the secondary side into a medium-voltage network at 1-30 kV is particularly advantageous. As a rule, a transformer is not employed with low-voltage networks, the energy being fed directly. As a rule, feed is not performed directly from DC energy sources into high-voltage networks, which are first connected to a medium-voltage network in order to assemble sufficiently high energy capacity. For this reason, a preferred field of application of the proposed invention is to feed into a medium-voltage network in which the transformers have the appropriate properties.

### DRAWINGS

Further advantages emerge from the following description of the drawings. Exemplary embodiments of the invention are represented in the drawing. The drawing, the description and the claims contain a combination of numerous features. The person skilled in the art will also expediently consider the features individually and group them into useful further combinations.

The drawing shows in:

FIG. 1 a circuit diagram of a network feed device according to the prior art;

FIG. 2 a circuit diagram of a first exemplary embodiment of the invention for a three-phase network;

FIG. 3 a further exemplary embodiment for a three-phase supply network;

FIG. 4 signal curves of the output voltages and switching signals for an exemplary embodiment of the invention;

FIG. 5 a further exemplary embodiment for a network feed device in accordance with the invention with high security against failure;

FIG. 6 a further exemplary embodiment for a network feed device in accordance with the invention for the connection of two DC energy sources;

FIG. 7 a further exemplary embodiment of a network feed device in accordance with the invention with filter and smoothing unit;

FIG. 8 a schematic illustration of an exemplary embodiment of a three-leg inductance of a filter and smoothing unit for the exemplary embodiment of FIG. 7;

FIG. 9 a further exemplary embodiment of a network feed device in accordance with the invention with filter and smoothing unit as a double inverter device combined into one physical assembly;

FIG. 10 a further exemplary embodiment of a network feed device in accordance with the invention with double inverter devices connected in parallel;

FIG. 11 a further exemplary embodiment of a network feed device in accordance with the invention with inverter units connected in parallel and with filter and smoothing unit;

FIG. 12 embodiments of chokes of a filter and smoothing unit according to an exemplary embodiment of the invention.

Components that are identical or similar are given the same reference numbers in the figures.

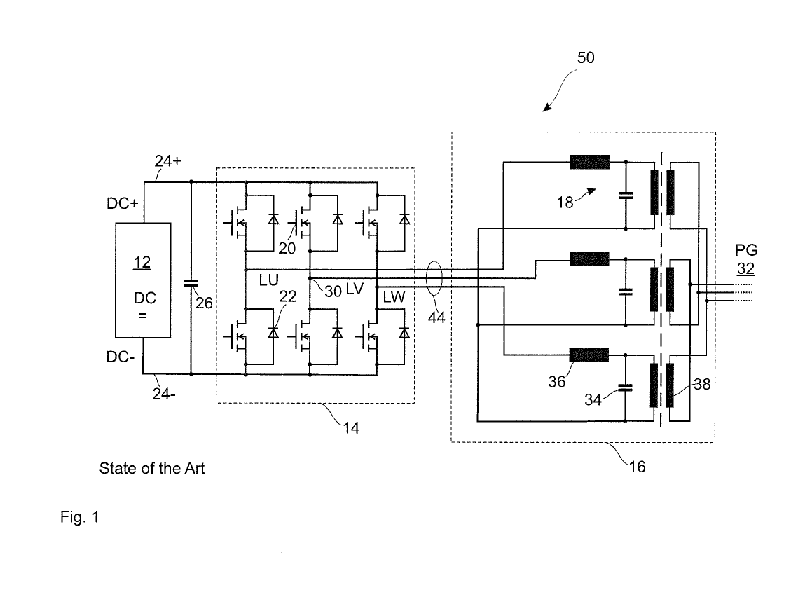

FIG. 1 shows a circuit diagram of a network feed device 50 according to the prior art. A DC energy source 12, for example a photovoltaic arrangement, feeds a DC intermediate circuit voltage, for example 450 V at the MPP specific to solar cells, into a DC intermediate circuit 24 which comprises a positive voltage potential 24+ and a negative voltage potential 24−. An intermediate circuit capacitor 26 is inserted into the DC intermediate circuit 24 for buffering and for voltage stabilization. An inverter unit 14 is inserted between the two intermediate circuit potentials 24+ and 24−, said inverter comprising three half-bridges 30, each half-bridge 30 comprising a power switching element 20, in particular a power transistor, IGBT or similar in the upper and lower partial branches, with a free-wheeling diode 22 connected in parallel, where the free-wheeling diode 22 protects the power switching element 20 from voltage peaks or damage when switching. Switching signals are applied by a higher-level control unit, not shown, to the switching inputs of the six power switching elements 20, in order to generate a line-to-line three-phase voltage (AC voltage) from the two direct current potentials 24+, 24−, which is fed to the transformer device 16 via a transformer feed line 44 that connects the three outputs of the half-bridges 30 to the transformer 38, in this case having a star connection. The transformer 38 can also be delta-connected. The transformer device 16 adjusts the voltage level of the AC voltage generated to the level of the supply network 32, and feeds the energy into the supply network 32. The secondary windings of the transformer 38 are delta-connected for this purpose. The network transformer device 16 comprises three network transformer windings 38 that provide electrical disconnection between the network feed device 10 and the supply network 32, adjust the voltage level and smooth out harmonics. To improve the quality of the PWM-modulated voltage signal of the inverter unit 14 that is delivered, each network transformer winding 38 is preceded by a smoothing unit 18 which comprises a filter inductor 36 and a filter capacitor 34. The magnetic and capacitive energies that can be stored in the inductor 36 and the capacitor 34 serve to smooth the delivered PWM signals of the inverter unit 14 in order to provide an AC voltage that is as harmonic is possible with low harmonic components which can be transferred via the network transformer windings 38 into the three-phase supply network 32.

The maximum output power on the alternating current side from such a network feed device 50 is limited by the maximum current and the AC output voltage of the inverter unit. The lowest MPP voltage that occurs in the DC intermediate circuit 24 limits the possible AC output voltage. Considerations of the efficiency and the physical size, and hence of the cost required for the power switching components 20, 22, 34, 36 and 38 that are involved, show that the highest possible three-phase AC voltage is desirable, since as a result of a higher voltage the losses for the same power undergo a squared reduction since the losses are above all a result of the current. With a network feed device known from the prior art comprising one inverter unit 14 in which each half-bridge 30 is associated with one network transformer winding 38 with a common star node or with delta connection, it is only possible to provide an effective line-to-line three-phase voltage U_{AC}<U_{MPPmin}/\sqrt{2}·0.9, where the 0.9 provides a 10% reserve for the regulation of tolerances, and at least one third harmonic zero sequence component is injected into the modulation. If such a network feed device 50 is used in typical photovoltaic systems which have for example a minimum MPP voltage of 450 V, then only an output voltage of about 290 V can be delivered on the three-phase side, which means that an upward transformation with corresponding transformation losses is necessary in order to feed, for example, into a 400 V three-phase supply network. In an exemplary 100 kW system, all the components on the three-phase side, i.e. inverter unit 14, network transformer device 16, smoothing unit 18, must be designed for a current load of up to 200 A, in order to provide the required electrical power. This makes the corresponding components relatively expensive and entails high conversion losses.

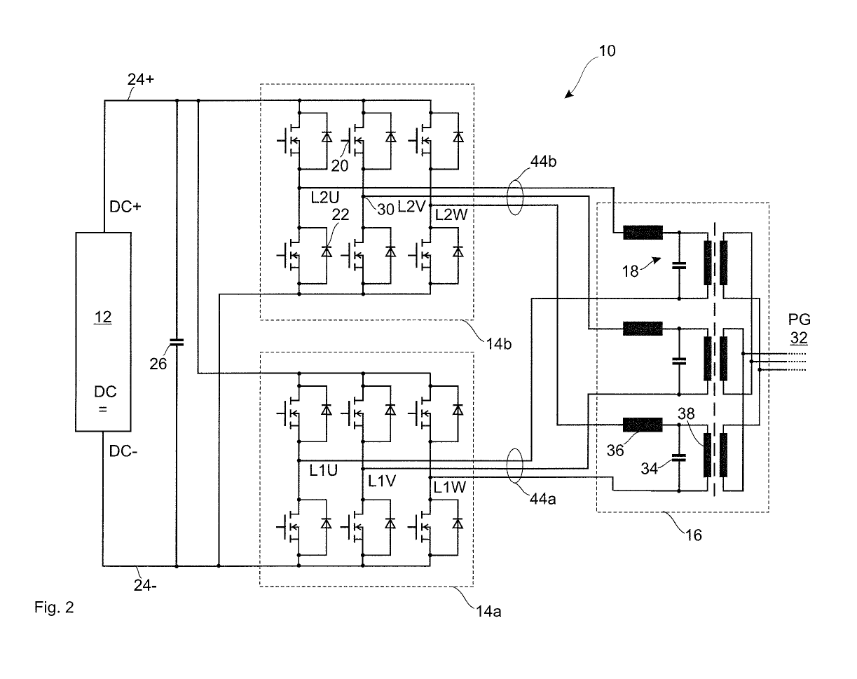

FIG. 2 shows a first exemplary embodiment of the invention, in which on the output side the transformer device 16 comprises three network transformer windings 38, whose primary winding terminals are brought out separately. The network feed device 10 comprises two inverter units 14a, 14b which are of similar construction and are connected in parallel to a common DC intermediate circuit 24 of the DC energy source. The DC intermediate circuit 24+/− is stabilized by an intermediate circuit capacitor 26. One primary-side network transformer winding 38 is connected between each half-bridge 30 of each of the two inverter units 14a and 14b via transformer supply lines 44a, 44b respectively. On the secondary side, the transformer 38 is delta-connected. Each network transformer winding 38 is preceded by a smoothing unit 18 for smoothing the AC voltage provided by the half-bridges 30. For operation of each network transformer winding 38, the half-bridges 30 of the first inverter unit 14a and of the second inverter unit 14b are subject to coordinated control, where the two half-bridges can be switched at the same clock frequency. An asynchronous operation is however also conceivable, in which for example the first inverter unit 14a determines the polarity of the AC voltage to be delivered and is switched synchronously with the supply network 32, and in which the half-bridges 30 of the second inverter unit 14b are operated at higher frequency, for example at 4 kHz, in order to provide a PWM modulation of the AC voltage to be delivered in order to improve the quality of the AC voltage to be delivered. With the solution shown, it is possible, for example during use in a photovoltaic application, to optimally exploit the MPP voltage range, where the AC output voltage provided can be increased by a factor of \sqrt{3} compared with the circuit illustrated in FIG. 1. This is achieved in that the star node of the network transformer device 16 is opened up and thereby each network transformer winding 38 can be connected separately to the independent windings with separate potentials, so that the transformer device 16 can be connected to six terminals. The opened star node is connected to the respective second inverter unit 14b. The other ends of each of the network transformer windings 38 are connected to the second inverter unit 14b. The two inverter units can therefore be synchronously clocked in coordination with one another in such a way that the maximum DC intermediate circuit voltage can be interconnected to deliver an increased AC voltage range. An improved efficiency with reduced current load is achieved in this way, so that ultimately more economical components with longer service life can be employed.

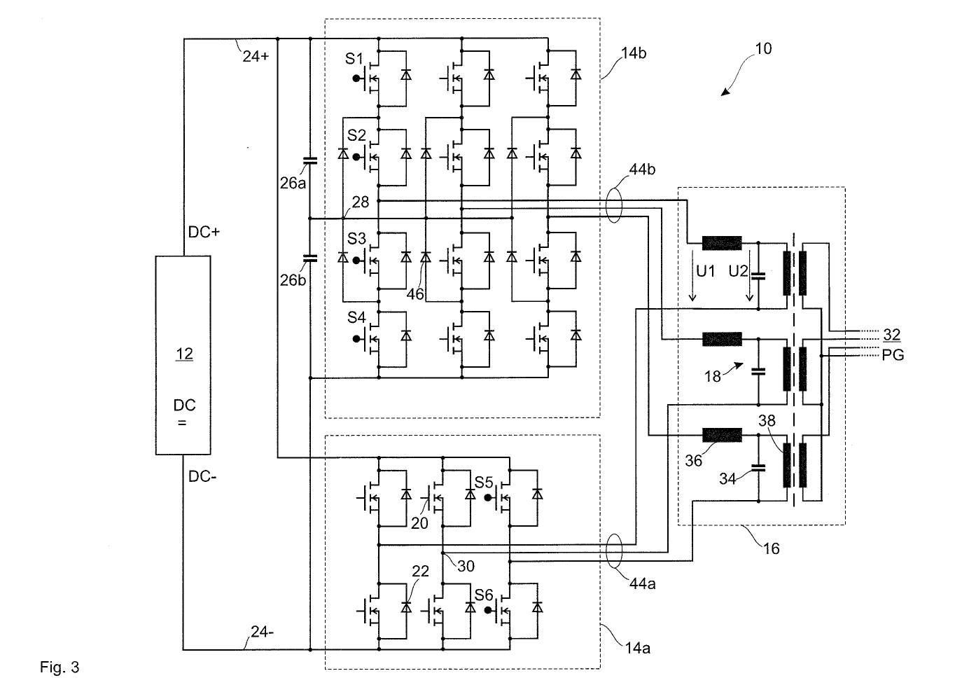

FIG. 3 shows a further exemplary embodiment of a network feed device 10 for an energy feed system for feeding in DC energy, for example a photovoltaic voltage source 12. The two DC voltage potentials 24+, 24−, are connected in parallel to two inverter units 14a, 14b. The first inverter unit 14a is a conventional 2-stage inverter comprising three half-bridges 30. The second inverter unit 14b is designed as a 3-stage inverter unit and comprises an artificial star node 28 (centre node) in order to deliver an output potential from each half-bridge 30 with the magnitude of the positive voltage potential 24+, the negative voltage potential 24− or the potential of the star node 28. The inverter unit 14a can deliver an output potential with the magnitude of the positive voltage potential 24+ or of the negative voltage potential 24− in each half-bridge 30. The resulting output voltage U1 between the outputs of the two inverter units 14a and 14b can thus adopt the values DC+, DC+/2, 0, DC−/2 or DC−, depending on the switch setting. DC here refers to the DC voltage in the intermediate circuit 24. A total of five voltage potentials of different magnitudes can therefore be delivered. The star node 28 of the second inverter unit 14b is connected by two intermediate circuit capacitors 26a, 26b to the two DC intermediate circuit voltage potentials 24+, 24− respectively. The intermediate circuit capacitors 26a, 26b are used to stabilize the intermediate circuit voltage. The half-bridges 30 of the two inverter units 14a, 14b are connected via transformer supply lines 44a, 44b to the respective connecting terminals of the network transformer windings 38 of the transformer device 16. The inverter unit 14b implemented as a 3-level inverter is particularly advantageous from the point of view of efficiency, since switching losses are reduced and an optimized sinusoidal curve of the AC voltage to be delivered can be achieved. On the secondary side of this exemplary embodiment, the transformer windings are star-connected, with the resulting star node being brought out to the supply network 32.

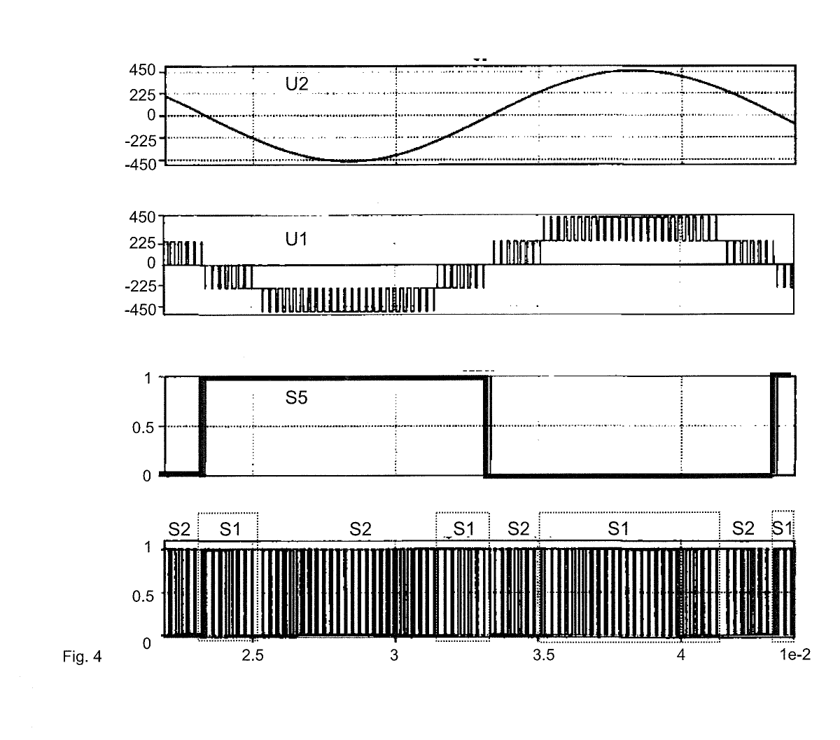

FIG. 4 refers to the exemplary embodiment of FIG. 3 and shows the output voltage curve U2 at the input to the network transformer winding 38, and the input voltage signal U1 before the smoothing unit 18 of FIG. 4, which can be accessed in the transformer device 16. The switching signals at the power switching element S5 of the first inverter unit 14a, and the switching signals S1, S2 at the power switching elements 20 of the second inverter unit 14b are also illustrated. The switching signal S5 of the first inverter unit 14a determines the polarity of the AC voltage half-wave to be delivered (positive or negative). A PWM modulation of the power switching elements S1, S2, which are switched at about 4 kHz, can be seen in the voltage curve U1, which appears as the difference of the half-bridge voltages of the two inverter units 14a, 14b. The high-frequency PWM modulation of the second inverter unit 14b is used for modulation of the sinusoidal wave U2 to be delivered to the network transformer windings 38. Thus, following the smoothing unit 18, a practically ideal sinusoidal voltage U2, i.e. an AC output voltage of high quality and with low harmonic content, is provided from the voltage U1. The signal curves illustrated in FIG. 4 of the voltage U2 at the transformer winding 38, the output voltage U1 before the smoothing unit 18, and the switching statuses of the IGBT S5 of the first inverter unit 14b as well as of the IGBT S1 and S2 of the second inverter unit 14b illustrate the switching statuses during one phase of the AC output voltage. S3 is switched complementarily to S1, with the provision of dead times, and S4 complementarily to S2, taking into account dead times. S6 is switched complementarily to S5 taking into account dead times. With a switching frequency of the second inverter unit 14b of 4 kHz, and an intermediate circuit voltage of 450 V, an effective output voltage of about 290 V is hence provided in each phase and at each transformer winding 38. This voltage can be provided in each phase with the invention illustrated. In the prior art, this 290 V output voltage is only provided as a line-to-line magnitude between two phases, which would yield a voltage of 165 V at each transformer winding 38 of a star-connected transformer (see FIG. 1). This relationship yields the AC output voltage gain larger by a factor of \sqrt{3}.

It follows that the first inverter unit 14a is connected by the transformer supply line 44a with the winding ends of the network transformer windings 38 to the negative intermediate circuit potential 24− during the positive half-wave of the output voltage and to the positive intermediate circuit potential 24+ during the negative half-wave. The inverter unit 14a is switched, synchronously with the network, at a clock rate of 50 Hz, and negligible switching losses occur. The second inverter unit 14b performs the modulation of the sinusoidal voltage U1 at a higher clock frequency of, usually, 4 kHz. Since the three winding ends of the transformer device 16 are not connected via a star node to the other windings, but are connected to 24− or to 24+ depending on the half wave, the inverter unit 14b makes available the full voltage swing of the DC intermediate circuit 24 in each half wave for the modulation of the voltage for each individual phase. The maximum achievable effective output voltage is given by U_{AC}<U_{MPPmin}·\sqrt{3}/\sqrt{2}·0.9, and is hence greater by a factor of \sqrt{3} than the output voltage of the network feed device 50 according to the prior art illustrated in FIG. 1. For example, the output voltage with a minimum MPP voltage of a photovoltaic cell of 450 V is now about 500 V_{AC} line-to-line. The output current in a 100 kW system is hence reduced to about 115 A, whereby a significant reduction in the conversion losses and a lower current load can be achieved and more economical components can be employed.

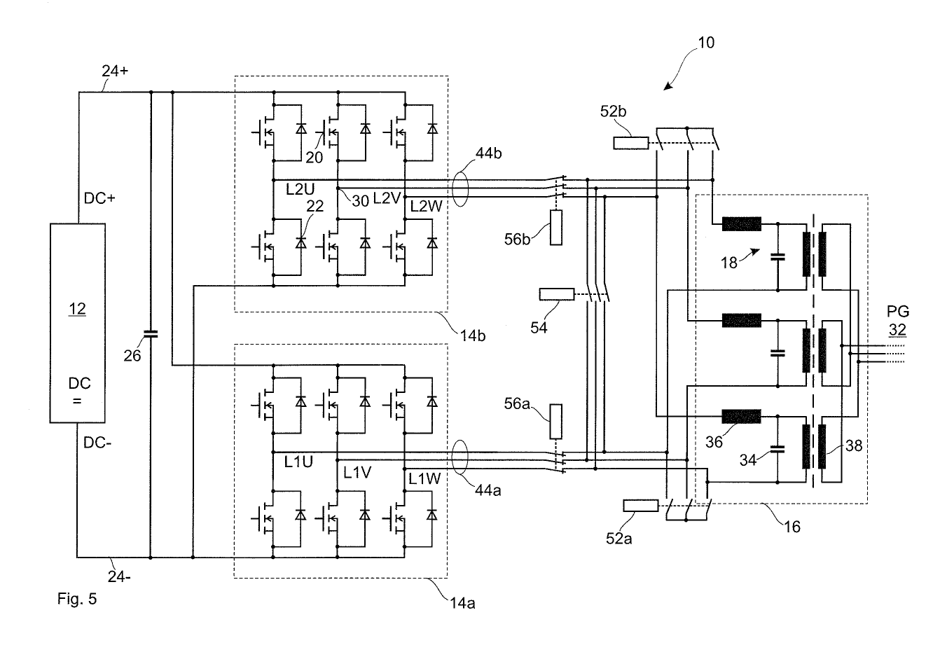

The exemplary embodiment of FIG. 5 corresponds substantially to that of FIG. 2, although here an inverter with 3 or more stages can be used as the first or second inverter unit 14a, 14b. As an extension, a decoupling/switching device 56a/b is added, allowing one contact side of the primary windings 38 to be released from the respective inverter unit 14a/b, and, when the corresponding inverter unit 14a/b has been released or is inactive, allowing the primary windings to be switched into a short-circuited star configuration by a corresponding star node switching device 52a/b or into a delta configuration by a delta switching device 54. The decoupling/switching device 52 can be omitted provided the inverter units 14 cannot create short-circuits, and provided a star or delta configuration of the primary windings 38 leaves the inverter units 14 unloaded. The corresponding switching devices can be implemented electro-mechanically as contactors, or as power electronic components. If open-circuit voltages are high, it is possible when starting up the network feed device to first begin in a star configuration and later consider a delta configuration, before it is possible to switch to a double inverter operating mode. In the event of failure of one inverter unit 14, the remaining unit 14 can, after switching over into a star or delta configuration, at least continue operation with reduced power. The circuit becomes significantly more robust, in particular for applications that require high robustness.

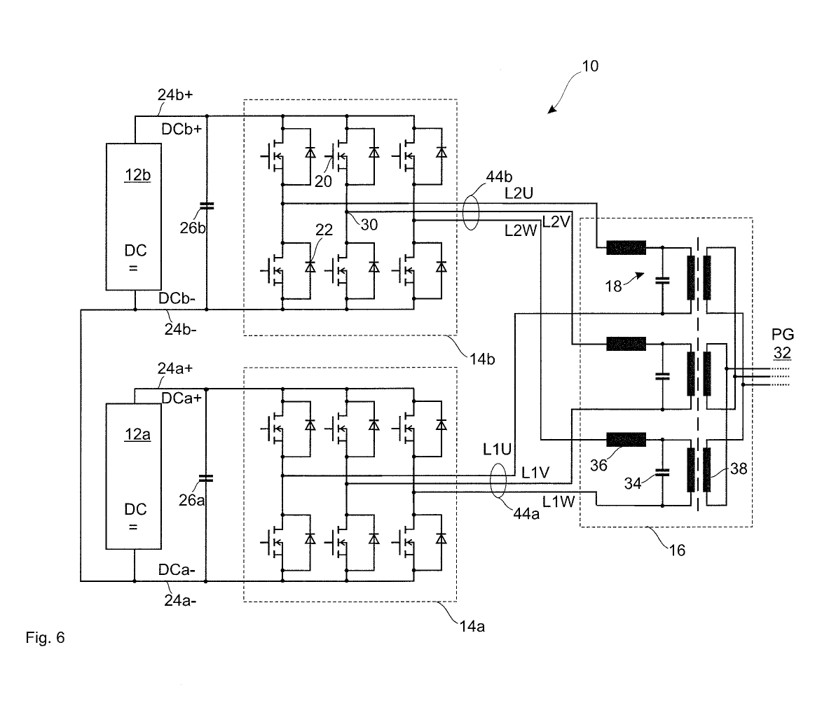

FIG. 6 furthermore proposes operation of two DC energy sources 12a/b, which are preferably of the same type but which can however also be two different types of energy source, for example photovoltaic cells and fuel cells, by an energy supply device 10 in accordance with the invention. The first DC energy source 12a is connected directly to the DC intermediate circuit 24a of the first inverter unit 14a, and the second DC energy source 12b directly to the DC intermediate circuit 24b of the second inverter unit 14b. This exemplary embodiment is advantageously used in combination with switching devices according to FIG. 5, so that in the event of failure or of different power capability of the two energy sources 14a/b it is possible to switch over to single inverter operating mode or to switch off one inverter unit 14. At least one DC− contact side of the two energy sources 24a/b—are connected to one another in order to ensure a flow of current between both energy sources 12a/b. Both intermediate circuits 24 are supported by intermediate circuit capacitors 26a/b. The DC energy sources 12 and the inverter units 14 can be dimensioned economically for lower power, and can nevertheless deliver an increased power to the energy supply network 32.

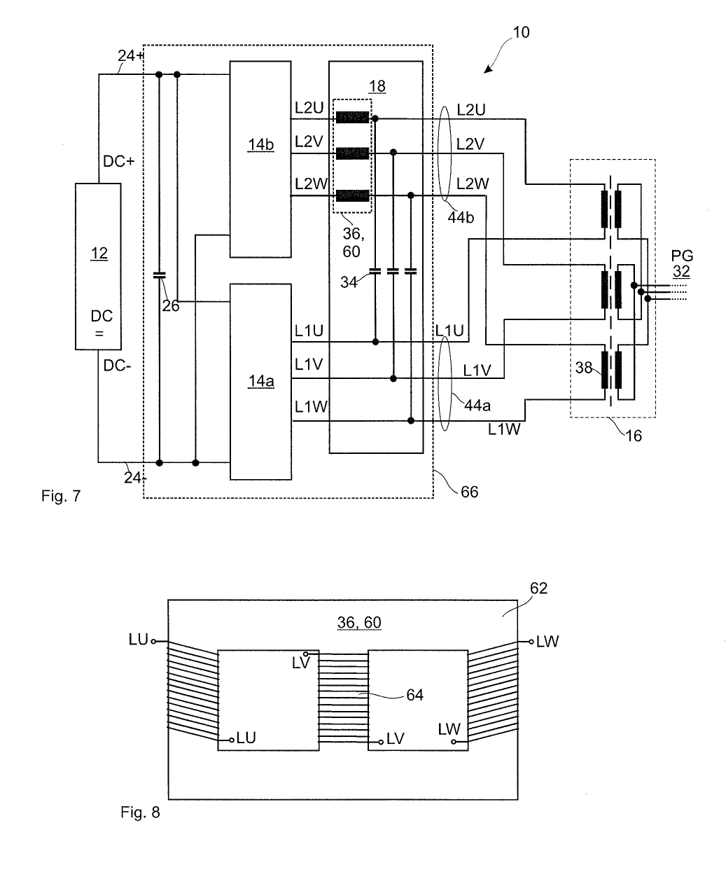

FIG. 7 shows a further exemplary embodiment of a network feed device in accordance with the invention with filter and smoothing unit based on the embodiments of FIG. 2 or 3. Each of the inverter units 14a, 14b can be made in two or three stages. It is conceivable that one of the two inverter units 14a is operated synchronously with the network and the second inverter unit 14b is operated at a higher frequency. One possibility here is to design the first inverter unit 14a in two stages, and the second inverter unit 14b, which is intended to make the voltage to be delivered approach a sinusoidal form and to smooth out harmonics, in three or more stages, or to have lower switching losses. The filter and smoothing unit 18 is integrated into one assembly which is inserted into the three-phase outputs LU, LV, LW of the inverter units 14a, 14b. Filter inductors 36 are inserted into the output phases L2U, L2V and L2W of the second inverter unit 14b and, as illustrated in FIG. 8, are wound jointly onto a three-leg coil body 62 of a choke 60. This achieves a compact physical form for the filter inductor 36 and a high stray inductance. Filter capacitors 34 are inserted between the corresponding output phases L1U-L2U, L1V-L2V and L1W-L2W, and these provide in combination with the three-leg filter choke 60 LC filtering of harmonics as well as the suppression of loop currents. The three-leg choke 60 has an essentially three-leg coil carrier 62 with three coil-carrying legs 64, but can however also comprise just one common leg onto which all the choke coils can be wound. One output phase of a half-bridge of the inverter unit 14b is passed through each choke coil, where the coil carrier 62 provides a high stray inductance in order to form a high inductive impedance to harmonics that occur and to offer low power losses compared to a current with network frequency.

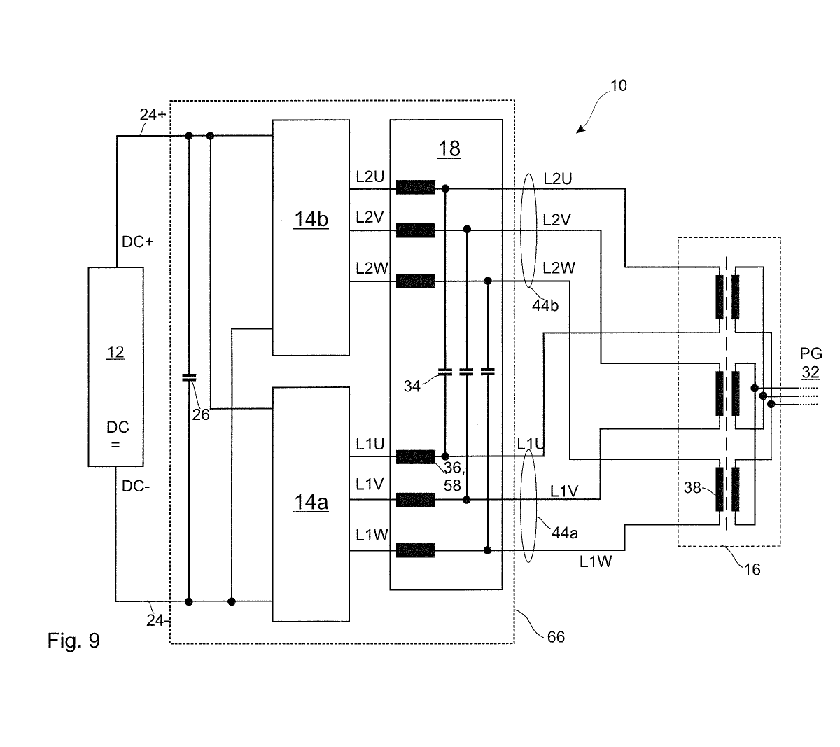

FIG. 9 represents a network feed device 10 that is also based on the embodiments in FIG. 2 or 3, and further develops the embodiment according to FIG. 7. The inverter units 14a, 14b can be designed in two or three stages. The filter and smoothing unit 18 is integrated into one assembly which is inserted into the three-phase outputs LU, LV, LW of the inverter units 14a, 14b. After passing the output phases of the inverter unit through the filter and smoothing unit 18, corresponding phases of the inverter outputs L1U & L2U, L1V & L2V and L1W & L2W are connected to the primary-side coils 38 of the transformer device 16. The filter and smoothing unit 18 comprises for each phase output L1U, L1V, L2W, L2U, L2V and L2W a current-compensated choke 58 as a filter inductor 36 as well as filter capacitors 34 that are connected between the phases of the inverter units 14a, 14b corresponding to a primary coil 38 of the transformer device 16. Two filter inductors 36 as current-compensated chokes 58 and a filter capacitor 34 respectively form an LC network which on the one hand suppresses harmonics as a low-pass filter and on the other hand attenuates loop currents between half-bridges of different primary coils 38 by the current-compensated effect of the chokes 58.

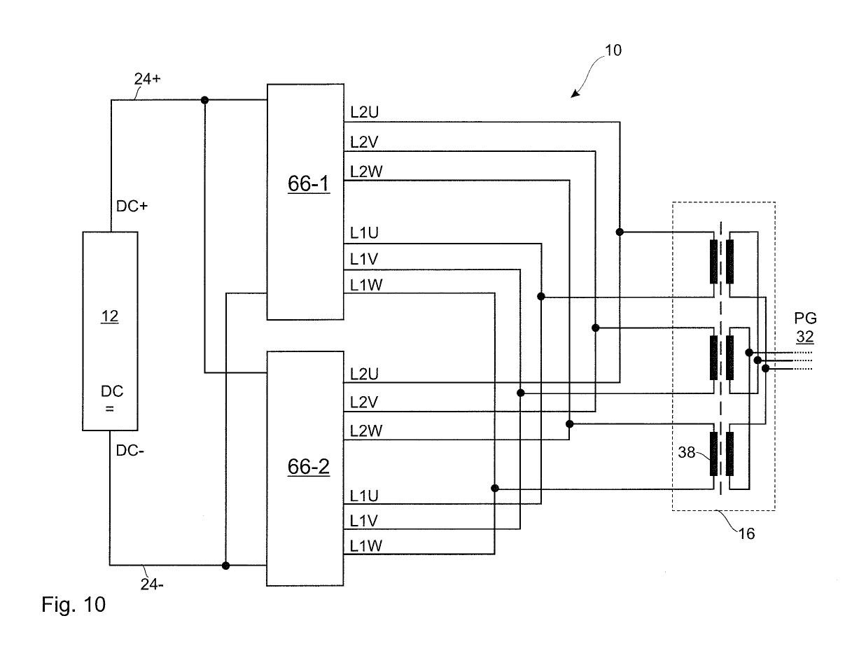

FIG. 10 shows a further exemplary embodiment of a network feed device in accordance with the invention with double inverter devices 66 connected in parallel. Each double inverter device 66 holds two inverter units 14a and 14b and with a filter and smoothing unit according to the exemplary embodiment of FIG. 9. The output phases L1U, L1V and L1W of the first inverter unit 14a of the first double inverter device 66-1 are connected to the output phases L1U, L1V and L1W of the first inverter unit 14a of the second double inverter device 66-2, and in the same way the output phases L2U, L2V and L2W of the second inverter unit 14b of the first double inverter device 66-1 are connected to the output phases L2U, L2V and L2W of the second inverter unit 14b of the second double inverter device 66-2. In this way double feed power can be provided, where optionally switching elements, not shown, between the two double inverter devices 66-1, 66-2 permit switching between the two double inverter units 66-1, 66-2 or allow one of the two to be switched in in order to provide redundancy and scalability, and also to permit emergency operation in the event that one double inverter device 66 fails. A double inverter unit 66 can be integrated into one assembly and integrated monolithically into a network feed device, and has two DC voltage inputs as well as two 3-phase outputs for connection to the primary windings 38 of the transformer device 16. A parallel connection of the double inverter devices 66-1, 66-2 is permitted by the filter and smoothing unit 18, and in particular by the filter inductors 36 inserted into the respective output phases. It is self-evident that further double inverter devices 66 can be connected in parallel without difficulty in order to further increase a delivered power, for example when the power delivered by the DC voltage source is increased by extension measures.

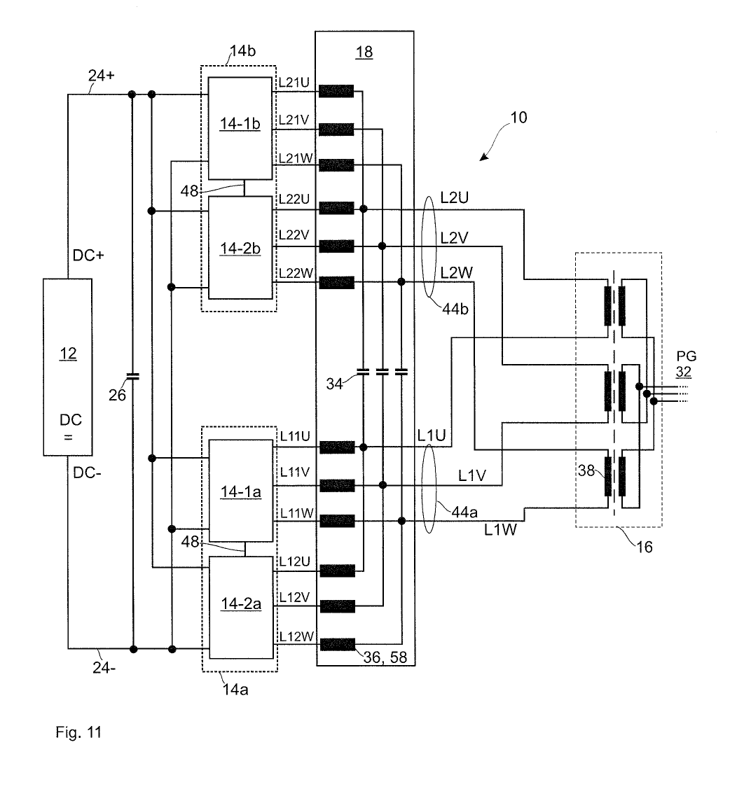

The embodiment of a network feed device according to FIG. 11 is based on the concept of the circuit of FIG. 9 and FIG. 10, and represents the concept of FIG. 10 in an alternative and detailed circuit diagram not oriented around assemblies, where in this case two inverter units 14-1a and 14-2a are connected in parallel to form one inverter unit 14a and two inverter units 14-2a and 14-2b are connected in parallel to form one inverter unit 14b, and can be operated synchronously with one another. The filter and smoothing unit 18 accordingly comprises filter inductors 36 for each output phase L11U, L11V, L11W of the inverter unit 14-1 a, and filter inductors for each of the output phases L12U, L12V and L12W of the second inverter unit 14-2a of the inverter unit 14a. This applies correspondingly to the inverter units 14-1b and 14-2b of the second inverter unit 14b. Otherwise the filter and smoothing unit 18 is constructed as in the circuit according to FIG. 7. The two inverter units 14-1a, 14-2a and 14-1b, 14-2b are connected in parallel and can be connected to one another by a synchronizing line 48. The half-bridge switching elements of the two inverter units 14-1a, 14-2a and 14-1b, 14-2b can be driven simultaneously by the synchronizing line 48, or said line can be used to synchronize the generation of PWM switching signals of the PWM control devices, not shown, of the inverter units 14-1, 14-2. It is however also possible to operate the two parallel-connected inverter units 14-1a, 14-2a and 14-1b, 14-2b in a non-synchronized manner, where advantageous effects can however still be achieved by approximately synchronous operation, and the amount of wiring can be reduced.

Connecting together the half-bridge outputs of two inverter units operated in parallel is permitted by the coupling via the current-compensated chokes 58, where harmonics are attenuated and unwanted loop currents and common-mode components can be suppressed. By a parallel operation of two or more inverter units, the feed-in power can be increased by the use of economical inverters of limited power, redundancy is created and the susceptibility to faults lowered. An inverter that is connected in parallel can also be switched in or out as required, so minimizing switching losses in order to make a needs-based inverter capacity available that corresponds to a quantity of energy to be fed in. By the use of low-power, economical inverters operating in parallel, cascading is created, and the feed-in power of existing systems can be scaled up or subsequently expanded, where parts of an already existing network feed circuit can continue to be used.

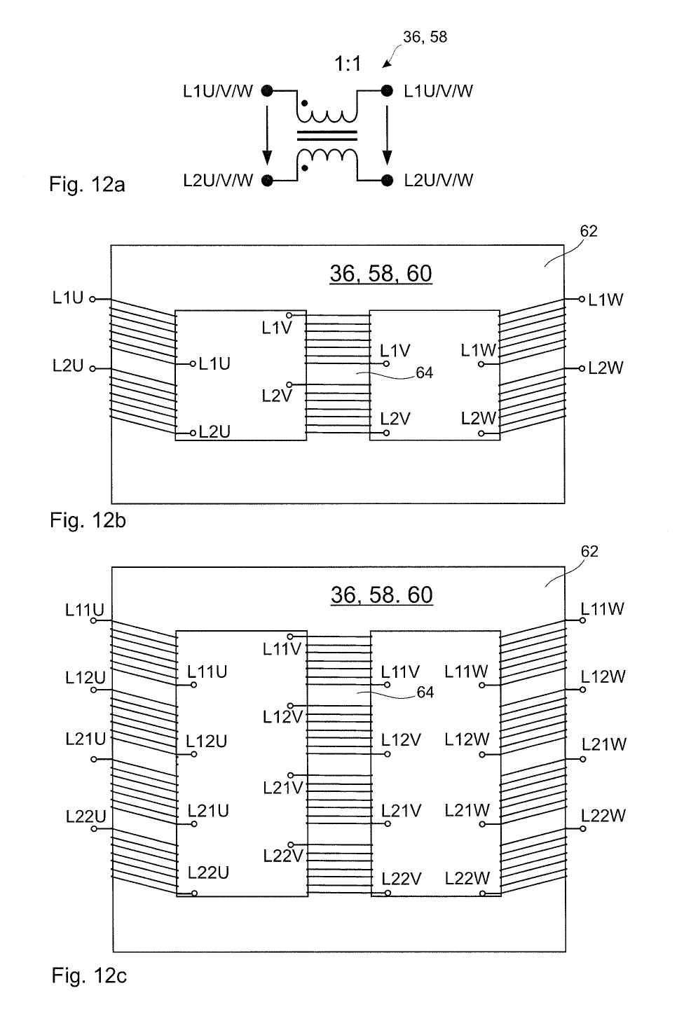

FIG. 12 shows firstly in FIG. 12a an equivalent circuit diagram of a current-compensated choke 58 as a filter inductor 36 comprising a double-pole input and output for a feed and return line L1U/V/W, L2U/V/W between the corresponding half-bridges of the two inverter units 14a, 14b in double inverter operating mode, and an associated primary coil 36 of a transformer device 16. The common-mode choke 36 has two coils through which the coil current of the primary coil 36 flows in opposite directions, so that the magnetic fields in the core of the choke 58 are cancelled out and common-mode interfering currents are heavily attenuated due to the high inductance of the choke 58. For loop currents between the two inverter units, the choke 36 has a very high inductance, since their magnetic fields in the yoke of the choke do not compensate but reinforce one another.

FIGS. 12b and 12c shows schematically possible structural forms of three-leg coil carrier 62 of a current-compensated three-phase choke 58 through each of which currents for the feed and return lines of a primary coil 38 of a transformer device 16 can pass. The phase outputs of the corresponding half-bridges of the inverter units 14a, 14b are each wound in opposite directions around a single leg 64 of the three-leg coil carrier 62, so that common-mode loop currents can be suppressed. Each leg 64 carries coils for the feed line to a primary winding 38 of the network transformer device 16. The coil carrier 62 comprises a series of laminated metal layers in order to suppress eddy currents and to be able to provide a high stray magnetic inductance. FIG. 12c shows a filter inductor 36 as a three-leg choke 60 which can be incorporated in a filter and smoothing unit 18 of a network feed device 10 according to FIG. 8. The three-leg choke 60 carries four coils on each leg 64, where in each case two coils are associated with the half-bridges of the parallel-connected inverter units 14-1a, 14-2a of the first inverter unit 14a, and two coils wound in opposite directions are associated with the half-bridges of the parallel-connected inverter units 14-1b, 14-2b of the second inverter unit 14b. A compact physical form of a current-compensated decoupling choke 36 of a filter and smoothing unit 18 is thus proposed, by which two or more inverter units operated in parallel can be connected to one another to form one inverter unit, so that the feed-in power can be economically increased by parallel operation.

The circuit variants illustrated in FIG. 5 and FIG. 6 for an increased security against failure by the addition of switching devices 52, 54, 56 and the operation of two DC energy sources 12a/b within one network feed device 10 can be integrated in any required way using one of the exemplary embodiments illustrated in FIG. 2, 3, 6, 7, 9, 10 or 11 or using any required mixture of these.

The illustrated network feed device with double inverter topology results in a marked increase in efficiency, since the ohmic losses in the transformer device 16 and in the smoothing inductors 36 have a square relation to the current I. The inverter losses of the second inverter unit 14b can be markedly reduced. However, further inverter losses are added by the use of a pair of inverter units 14a, 14b, but are correspondingly low, as conduction losses, when the first inverter unit 14a is clocked at a low frequency of 50 Hz corresponding to the network frequency. The reduction in losses in the rest of the components and in the overall system significantly over-compensates for these additional losses. An overall improvement in efficiency of typically between 0.3 and 1% results. The second inverter unit 14b can usually be designed as a standard 2-stage inverter unit. The variant as a 3-stage inverter unit offers the advantage that the switching losses can be significantly reduced, and hence the overall system achieves an even higher efficiency.

1-21. (canceled)

22. Network feed device for feeding electrical energy from at least one DC energy source into a three-phase AC supply network, where the DC voltage of a DC intermediate circuit is converted by means of at least one inverter unit into a three-phase voltage and is fed by means of a transformer device comprising three network transformer windings into the AC supply network, whereby a first winding terminal of the network transformer winding is connected to a half-bridge of a first inverter unit, and a second winding terminal of the network transformer winding of the transformer device is connected to a half-bridge of a second inverter unit, wherein the first inverter unit is operated synchronously with the network, in particular at 50 Hz or 60 Hz, to define the polarity of the supply network voltage to be delivered, and the second inverter unit is operated at a higher-frequency PWM cycle, in particular greater than 500 Hz, for modulation and smoothing of the supply network voltage to be delivered.

23. Network feed device according to claim 22, wherein the transformer unit is a three-phase transformer with separable primary winding terminals accessible from outside, where the two connecting terminals of each primary winding are connectable from outside.

24. Network feed device according to claim 22, wherein a filter and smoothing unit is incorporated between the inverter units and the transformer device, in particular before each primary winding of the transformer device.

25. Network feed device according to claim 24, wherein a filter inductor of the filter and smoothing unit is arranged in series with each primary winding.

26. Network feed device according claim 25, wherein the filter inductor comprises two chokes that are inserted into the forward and reverse phases Li U-L2U, L1V-L2V, LIW-L2W of the primary winding.

27. Network feed device according claim 26, wherein the chokes of the filter inductor of the forward and reverse phases L1U-L2U, L1V-L2V, L1W-L2W have a current-compensated design.

28. Network feed device according to claim 25, wherein the filter inductors are wound on a multi-leg coil carrier, in particular a three-leg coil carrier.

29. Network feed device according to claim 24, wherein two or more inverter units are connected in parallel and operated synchronously to form an inverter unit, where the output phases L11U & L12U, L1IV & LI2V, LI1W& L12W, L2IU & L22U, L2IV& L22V and L2IW& L22W are coupled to one another via chokes.

30. Network feed device according to claim 29, wherein at least the inverter units of the two inverter units and the associated output-side filter and smoothing units are brought together in a common assembly of the double inverter device, and two or more double inverter devices are connected in parallel, where the output phases of the inverter units of the two inverter units included in the double inverter devices are connected to one another.

31. Network feed unit according to claim 22, wherein at least the second inverter unit is an inverter unit with three or more stages with star node.

32. Network feed unit according to claim 22, wherein in the DC intermediate circuit between the DC energy source and the two inverter units, an intermediate circuit capacitor is connected between the positive and negative intermediate circuit potentials and the star node respectively.

33. Network feed device according to claim 22, wherein a switching device for decoupling from the inverter unit and/or for Y-(star) and/or A-(delta) connection of the winding terminals is provided at the first and/or second winding terminals of the network transformer windings.

34. Network feed device according to claim 22, wherein the first inverter unit is connected to a first DC energy source, and the second inverter unit to a second DC energy source.

35. Energy feed system comprising a DC energy source and a mains feed apparatus according to claim 22, wherein the DC energy source is a photovoltaic source, a fuel cell source, a battery source or a mechanically operable generator with rectifier.

36. Method for operating a network feed device according to claim 22, whereby the first and the second inverter unit are operated in a coordinated manner such that the voltage acting on each primary coil of the transformer device is adjustable between an amplitude of 0 V up to the intermediate circuit potential DC+/DC, comprising operating first inverter unit to determine the polarity of the supply network voltage to be delivered synchronously with the network frequency, in particular in a 50 Hz or 60 Hz cycle, and operating the second inverter unit a higher PWM frequency, in particular greater than 500 Hz, for modulation and smoothing of the supply network voltage to be delivered.

37. Method according to claim 36, comprising switching in at least the second inverter unit in at least three voltage stages for PWM-modulated smoothing of the supply network voltage.

38. Method according to claim 36, comprising connecting the parallel-connected inverter units to one another for an increase in power on the output side via a filter and smoothing unit and operating the same synchronously.

39. A network feed device according to claim 22 coupling a photovoltaic source, a fuel cell source, a battery source or a mechanically operable generator to an AC supply network, or for the operation of an AC consumer, in particular an AC motor, and means for operating the inverter unit with a variable frequency corresponding to the speed of rotation of the AC motor.

40. A network feed device according to claim 39 connected for direct energy feed on the secondary side into a medium-voltage network of 1-30 kV.

41. A network feed device according to claim 39 connected for direct energy feed on the secondary side into a medium-voltage network of 1-30 kV.
